(19) United States
(12) Patent Application Publication
(10) Pub. No.: US 2025/0222472 A1
(43) Pub. Date: Jul. 10, 2025

(54) POWDER SPRAY DEVICE AND METHOD OF CONTROL

(71) Applicant: Nordson Corporation, Westlake, OH (US)

(72) Inventors: Sergey GUSKOV, Meerbusch (DE); Sergey SALENKO, Düsseldorf (DE)

(73) Assignee: Nordson Corporation, Westlake, OH (US)

(21) Appl. No.: 18/848,965

(22) PCT Filed: Apr. 11, 2023
(86) PCT No.: PCT/US2023/018111

§ 371 Date: Sep. 20, 2024

Related U.S. Application Data
(60) Provisional application No. 63/330,664, filed on Apr. 13, 2022.

(51) Int. Cl. B05B 5/03; B05B 5/053

(52) U.S. Cl. CPC B05B 5/032; B05B 5/0533

(57) ABSTRACT

An electrostatic powder spray device comprises an air supply, a spray body, a voltage multiplication circuit, a sensor, and a controller. The air supply is configured to supply air with an input velocity. The spray body transmits an air and spray material combination along a flow path. The voltage multiplication circuit is configured to receive a voltage input and to produce a power supply output that is supplied to an electrode positioned along the flow path, the power supply output having an output voltage and an output load current. The sensor is configured to detect at least one of the output voltage and the output load current. The controller is operatively connected to the sensor and the air supply. The controller is configured to control the air supply to adjust the input velocity of the air based on the at least one output voltage and output load current.

### CROSS REFERENCE TO RELATED APPLICATIONS

This application is a National Stage Application of International Patent App. No. PCT/US2023/018111, filed Apr. 11, 2023, which claims the benefit of U.S. Provisional Patent App. No. 63/330,664, filed Apr. 13, 2022, the entire disclosures of both of which are hereby incorporated by reference as if set forth in their entirety herein.

### TECHNICAL FIELD

This disclosure relates generally to an electrostatic powder spray device, more particularly, to a spray device and method for automatic adjustment of spray velocity to effect spray pattern.

### BACKGROUND

Electrostatic spray guns are used for various applications to spray liquid and/or powder coatings onto various moving or stationary objects and parts. Generally, the coating is atomized and emitted as a cloud of liquid droplets or powder particles from the end of the gun having a high voltage electrode. The electrode creates an electric field and an ion flux through which the sprayed particles pass, and the ion bombardment electrostatically charges the atomized coating particles passing through the ion-rich electric field. The electrostatically charged coating particles are then directed toward the object being sprayed, which is electrically grounded, so that the charged particles emitted from the end of the gun are attracted to the object to provide better adherence and coverage of the object with coating material. “Spray gun” as used herein includes any electrostatic spray device, whether or not hand-held, and whether or not configured in the shape of a pistol.

Many hand-held electrostatic spray guns utilize an internal high voltage power supply to the charging electrode. These spray guns have a low level voltage input, for example from 12 to 30 volts DC, which is boosted by the internal power supply of the gun to a level that is desirable for the charging electrode, usually 50 kilovolt (KV) or more. A low voltage level input allows the input power line to the gun to be smaller and more flexible, and hence more maneuverable, because it is not necessary to insulate the line to handle high voltage levels. The internal power supply has a voltage multiplier section or circuit that increases the low level supply voltage to a voltage level that is sufficiently high to electrostatically charge the spray particles. The multiplier circuit generally operates according to a characteristic power loadline which represents a relationship between the voltage on the charging electrode and the amount of charge, for example, current, emitted from the electrode(s).

The characteristic power loadline of a spray gun multiplier circuit determines the quantity and distribution of charge delivered to the spray particles, and thus controls the quality of the coating on the object being sprayed. Typically, the characteristic power loadline of the gun multiplier circuit is such that the output electrode voltage decreases as the load current delivered to the spray particles increases, and the external impedance between the charging electrode and ground reference decreases. The loadline determines the rate at which the output voltage drops with an increase in load current. The load current will tend to increase and the voltage on the electrode will consequently decrease as the grounded article being sprayed moves closer to the tip of the spray gun electrode, such as when objects moving along a production line pass closer to the gun electrode or when the gun (and electrode) is actually manipulated closer to the object to spray recesses or cavities located in it. Regardless of how the load conditions change, the load current and the output voltage generally will fluctuate during the spray application, affecting the quantity of charge on the particles and the quality and efficiency of the coating application. Therefore, while the gun may operate in the optimal range along the power loadline for a period of time during a spray application, at other times during the same spray application, it may operate non-optimally because of fluctuating electrostatic conditions.

The foregoing background discussion is intended solely to aid the reader. It is not intended to limit the innovations described herein. Thus, the foregoing discussion should not be taken to indicate that any particular element of a prior system is unsuitable for use with the innovations described herein, nor is it intended to indicate that any element is essential in implementing the innovations described herein.

### SUMMARY

The foregoing needs are met, to a great extent, by the electrostatic powder spray device described herein.

An aspect of the present disclosure provides an electrostatic material spray device. The electrostatic material spray device comprises an air supply, a spray body, a voltage multiplier circuit, a sensor, and a controller. The air supply is configured to supply air with an input velocity. The spray body defines a spray channel that is in fluid communication with the air supply and a spray material supply. The spray channel receives the air from the air supply and a spray material from the spray material supply and transmits an air and spray material combination along a flow path. The voltage multiplier circuit is configured to receive a voltage input and to produce a power supply output that is supplied to an electrode positioned along the flow path. The power supply output having an output voltage and an output load current. The sensor is configured to detect at least one of the output voltage and the output load current. The controller is operatively connected to the sensor and the air supply. The controller is configured to control the air supply to adjust the input velocity of the air based on the at least one of the output voltage and the output load current detected by the sensor. Control of the air volume influences the spray pattern size and velocity. Hence, the spray pattern can be optimized depending on the load conditions influenced, among others, by the gun to part distance. In some aspects, such as venturi applications, the air supply may not be separate from the spray material supply. In some aspects, such as dense-phase systems, the air supply may be separate from the spray material supply. In aspects, the spray material may be delivered to a sprayer by a pump, such as an ejector-style type pump or a dense-phase type pump. With both pump types, a volume of air may be used for spray material delivery and the creation of a spray pattern that can be controlled. In dense-phase systems, the pattern forming air may be added to the spray body of the gun, a spray nozzle, and/or the like offering a greater degree of the pattern velocity control independent of the powder output.

Another aspect of the present disclosure provides a method for controlling a material flow through an electrostatic powder spray device. The electrostatic powder spray device includes a spray body that defines a spray channel having an outlet. The method comprises: flowing air through the spray channel at an input volume; flowing a spray material through the spray channel such that an air and spray material combination flow through the outlet along a flow path; producing a power supply output that is supplied to an electrode, the power supply output having an output voltage and an output load current, the electrode being positioned within the flow path of the air and spray material combination; detecting at least one of the output voltage and the output load current; and adjusting the input volume of the air based on the at least one of the output voltage and the output load current. In aspects of the disclosure, there is a link between the volume of input air to the spray pattern velocity. In aspects of the disclosure, the goal is to control a pattern velocity and a pattern size. In this regard, a lower volume of air through the nozzle may generate a softer and/or a smaller resulting spray pattern. Conversely, a higher volume of air through the nozzle may generate a harder and/or a larger resulting spray pattern.

Another aspect of the present disclosure provides a control system for controlling an air flow through an electrostatic powder spray device. The electrostatic powder spray device is configured to spray an air and spray material combination to coat a spray part. The electrostatic powder spray device is further configured to provide a power supply output having an output voltage and an output load current to an electrode. The electrode is configured to provide a charge to the air and spray material combination. The control system comprises a sensor and a controller. The sensor is configured to detect at least one of the output voltage and the output load current. The controller is operatively connected to the sensor and an air supply. The controller is configured to control the air supply to adjust an input velocity of the air supplied by the air supply based on the at least one of the output voltage and the output load current detected by the sensor. In aspects, the disclosed methods may control one or more of a material flow, a mixture flow, and/or an air flow. In aspects, the disclosed methods operate to control the input air volume to generate a resulting output spray velocity.

This summary is provided to introduce a selection of concepts in a simplified form that are further described below in the Detailed Description section. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there are shown in the drawings illustrative embodiments of the disclosure. It should be understood, however, that the application is not limited to the precise arrangements and instrumentalities shown. In the drawings:

FIG. 1 illustrates a schematic of an electrostatic spray coating device, according to an aspect of this disclosure.

FIG. 2 illustrates a schematic of a voltage input circuit, according to an aspect of this disclosure.

FIG. 3 illustrates an example of an operational loadline of a multiplier circuit in the voltage control mode, according to an aspect of this disclosure.

FIG. 4 illustrates an example of an operational loadline of a multiplier circuit in the current control mode, according to an aspect of this disclosure.

FIG. 5 illustrates a flowchart depicting a method for controlling the flow of spray material through an electrostatic powder spray device, according to an aspect of this disclosure.

### DETAILED DESCRIPTION

Certain terminology used in this description is for convenience only and is not limiting. The words “axial”, “radial”, “circumferential”, “outward”, “inward”, “upper,” and “lower” designate directions in the drawings to which reference is made. As used herein, the term “substantially” and derivatives thereof, and words of similar import, when used to describe a size, shape, orientation, distance, spatial relationship, or other parameter includes the stated size, shape, orientation, distance, spatial relationship, or other parameter, and can also include a range up to 10% more and up to 10% less than the stated parameter, including 5% more and 5% less, including 3% more and 3% less, including 1% more and 1% less. The term “substantially” is intended to mean considerable in extent or largely but not necessarily wholly (but can include wholly) that which is specified. All ranges disclosed herein are inclusive of the recited endpoint and independently combinable (for example, the range of “from 2 grams to 10 grams” is inclusive of the endpoints, 2 grams and 10 grams, and all the intermediate values). The terminology includes the above-listed words, derivatives thereof and words of similar import.

Successful powder coating of recessed areas, corners, and/or the like often depends on the ability to optimize electrostatic charge, powder output, and the aerodynamic properties of the spray pattern. If a spray device is moved closer to the part being sprayed (e.g. spray part), or a portion of the spray part, the ability to reduce the spray velocity can greatly enhance the powder deposition in difficult to coat areas. This spray device described herein is configured to allow the spray pattern velocity, the powder output, or both to be automatically changed independent of the powder output depending on the gun-to-part distance.

Based on the voltage and/or current variation, it can be deduced that the gun is moved closer or farther from the coated product. In systems using dense-phase pumps, the volume of air added to the spray system in order to create the desired spray pattern can be quickly and easily adjusted in response to the deduced changes in the gun-to-part distance. It will be appreciated that the ability to change the velocity of the spray pattern is not limited to the dense-phase systems. Even with traditional venturi pumps, the “atomizing” air can be automatically adjusted to achieve similar results.

As an example, when coating electric enclosures, more air and faster spray pattern can be beneficial when coating large flat surfaces. Yet, when coating corners, it can be desirable to keep the powder output at a constant level but reduce the spray velocity to reduce the turbulence in the corners and enhance the powder deposition there. This can be highly advantageous in both manual and automatic applications. For example, when using robots to coat complex products, using multi-axis movers, or in manual applications, adjusting the air supplied to the spray gun based on the output voltage and/or the output load current can enhance powder deposition on the spray part.

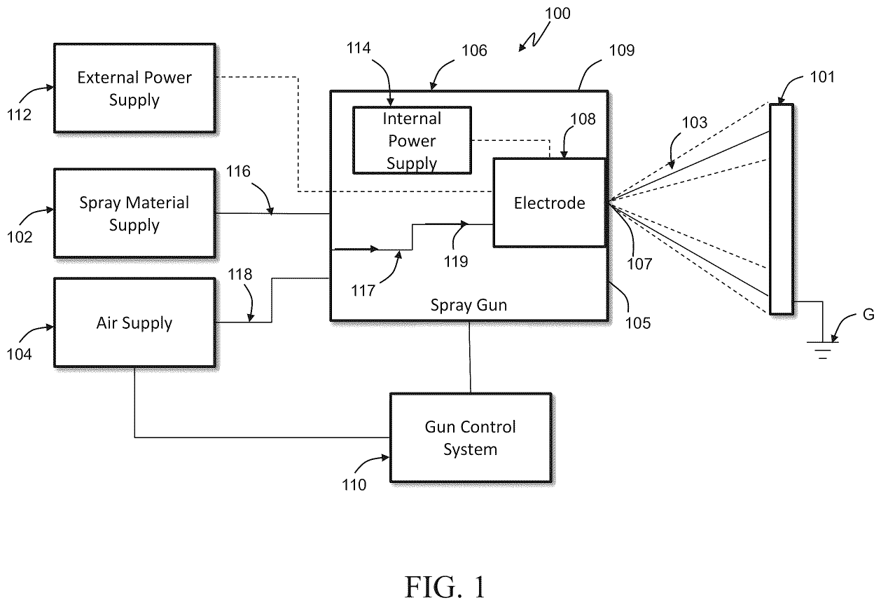

FIG. 1 illustrates a schematic of an electrostatic spray coating system or electrostatic spray coating device 100, according to an aspect of this disclosure. The aspects illustrated in FIG. 1 and described in relation to the same, may include, implement, utilize, and/or the like any other aspects, components, features, and/or the like of the disclosure as described herein. The electrostatic spray coating device 100 can be utilized to spray a part 101 with a coating or spray material 103. The electrostatic spray coating device 100 can be handheld and controlled by a movement of a user, can be controlled by, for example, a robotic arm or multi-axis mover, and/or the like. In an aspect, the electrostatic spray coating device 100 can be stationary. The electrostatic spray coating device 100 can comprise, for example, a dense phase system, a venturi pump system, or other coating system or device for coating spray parts with liquid and/or powder coatings.

The electrostatic spray coating device 100 can include a spray material supply 102, an air supply 104, a spray gun 106 with a charging electrode 108, and a gun control system 110. It will be appreciated that the charging electrode 108 can include one electrode or multiple electrodes. The electrostatic spray coating device 100 can also include one or both of an external power supply 112 and an internal power supply 114. The charging electrode 108 of the spray gun 106 can be powered by at least one of the external power supply 112 and the internal power supply 114. For example, the electrostatic spray coating device 100 can include a single one of the external power supply 112 and the internal power supply 114. The single power supply can provide the power to the electrode 108. Alternatively, the electrostatic spray coating device 100 can include an external power supply and an internal power supply such that parts of the power supply are located both externally and internally to the electrostatic spray coating device 100. The external power supply 112 can be connected to the spray gun 106 by, for example, a high voltage cable.

The spray material supply 102 is connected to the spray gun 106 by, for example, a tube, a hose, or other conduit 116. The spray material supply 102 supplies the spray material 103 to the spray gun 106 that is applied to the part 101. The material can include, for example, a powder, a liquid, combinations thereof, or still other material for coating the part 101.

The air supply 104 is connected to the spray gun 106 by, for example, a tube, a hose, or other conduit 118. The air supply 104 supplies air to the spray gun 106 that is combined with the spray material from the spray material supply 102 in a spray channel 117 of the spray gun 106. The spray channel 117 may be defined by a spray body 109 of the spray gun 106. The combination of the air and spray material 103 is sprayed through an outlet 107 of the spray gun 106 onto the part 101 to apply a coating onto the part 101. As the combination of the air and spray material 103 is sprayed by the spray gun 106, the air and spray material 103 may be in electrical contact with the electrode 108, a corona associated with the electrode 108, an electric field with the electrode 108, and/or the like. In order to enhance adherence of the spray material 103 onto the part 101, the part 101 may be connected to a ground G to ground the part 101.

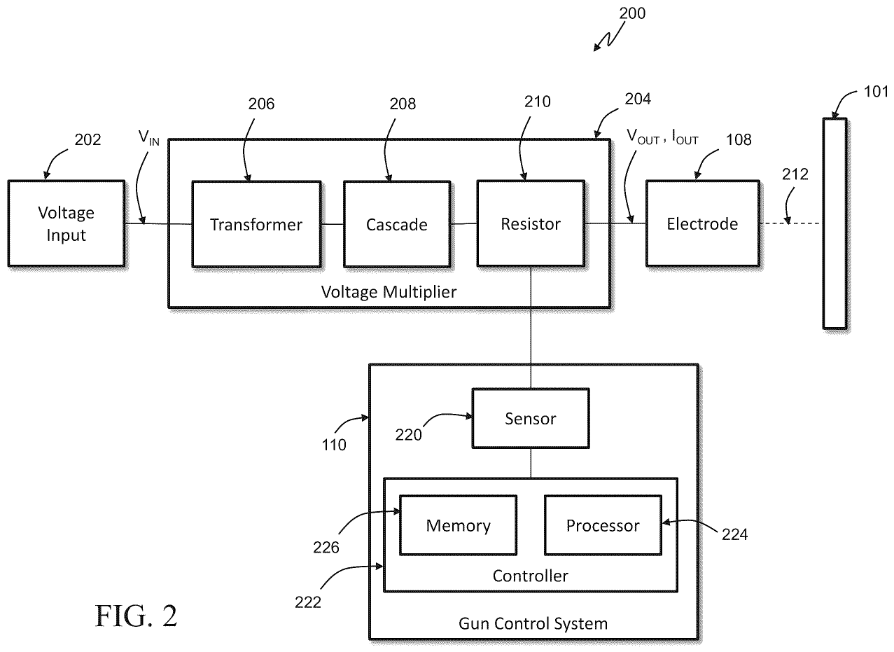

FIG. 2 illustrates a schematic of a voltage input circuit 200, according to an aspect of this disclosure. The aspects illustrated in FIG. 2 and described in relation to the same, may include, implement, utilize, and/or the like any other aspects, components, features, and/or the like of the disclosure as described herein. The voltage input circuit 200 may include a voltage input 202 and a voltage multiplier circuit 204. It will be appreciated that the voltage input circuit 200 can include fewer or more components. For example, the voltage input circuit 200 can include manipulation circuits, voltage limiting circuits, oscillators, sensors, or still other components. It will be appreciated that the external power supply 112, the internal power supply 114, or combinations of the external power supply 112 and internal power supply 114 utilize the voltage input circuit 200 to supply a charge to the electrode 108.

The voltage input circuit 200 may supply an input voltage VIN from a voltage input 202 to a voltage multiplier circuit 204. The voltage multiplier circuit 204 can include a transformer 206, a cascade 208, and a resistor 210. The voltage multiplier circuit 204 produces a power supply output that comprises an output voltage V_{OUT} and an output load current I_{OUT}.

A typical input voltage V_{IN} from the voltage input circuit 200 may range from 12to 30 volts DC, and is input to the transformer 206 and the cascade 208, which act as an input stage to the voltage multiplier circuit 204. The transformer 206 and cascade 208 may increase the input voltage to a level acceptable to the voltage multiplier circuit 204 (e.g. step-up transformer and cascade). The cascade 208 can include, for example, a diode bridge amplifier and/or the like. The voltage multiplier circuit 204 multiplies the input voltage V_{IN} to a high voltage output V_{OUT}, generally in the 10-150 kilovolt (KV) range. The corresponding output load current I_{OUT} can be in the range of 1-150 μA. The output voltage V_{OUT} of the voltage multiplier circuit 204 is supplied to the charging electrode 108. The charging electrode 108, which may be one or more high voltage charging electrodes, may be located proximate a tip 105 of the spray gun 106 where it creates a corona and/or an electric field 212. As atomized particles of the spray material 103 pass through the electric field 212, they acquire an electrostatic charge thereon. The charged particles are sprayed or otherwise conveyed toward the electrically grounded part 101, and when the charged particles pass in proximity to the part 101, they are attracted thereto. The charging of the spray material 103 promotes uniform material coating on the part 101. Atomization of the particles can be achieved in any of the well understood manners.

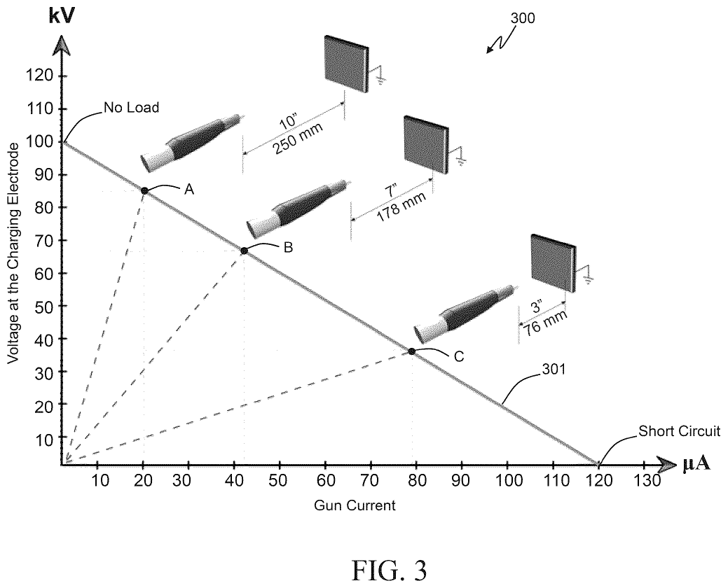

FIG. 3 illustrates an exemplary graph 300 of an operational loadline 301 of the voltage multiplier circuit 204 operating in a voltage limiting mode, according to an aspect of this disclosure. The aspects illustrated in FIG. 3 and described in relation to the same, may include, implement, utilize, and/or the like any other aspects, components, features, and/or the like of the disclosure as described herein. The voltage multiplier circuit 204 operates according to what is generally referred to as a power loadline which defines the relationship between the output or load current level I_{OUT} and the output voltage level V_{OUT} of the voltage multiplier circuit 204. Typically, there is a decreasing relationship between the output voltage V_{OUT} and the load current I_{OUT}. That is, as the load current I_{OUT} increases, the output voltage V_{OUT} decreases. More specifically, an actual voltage at the charging electrode 108 decreases. In this regard, the controller 222 does not decrease the output voltage level V_{OUT}. The output voltage level V_{OUT} shows a that voltage value. The operational loadline 301 corresponds to an approximately constant 100% voltage output. In this regard, the voltage output may be set by the controller 222. As shown in FIG. 3, an increase in load current I_{OUT} can be indicative of a reduced impedance between the gun and a part which corresponds to a closer gun-to-part distance. During operation of the voltage input circuit 200, an increase in load current I_{OUT} will normally occur when the tip 105 of the spray gun 106 and the charging electrode 108 are moved in close proximity to the grounded part 101 that is being sprayed. For example, the spray gun 106 may be moved closer to the part 101 to spray a recess or indentation within the part 101. Accordingly, this location closer to the part 101 results in an increase in load current I_{OUT}.

The input voltage V_{IN} to the voltage multiplier circuit 204 may determine the operational loadline 301 at which the voltage multiplier circuit 204 operates. Spray gun power supplies can have a constant input voltage V_{IN} which is chosen to yield an operational loadline 301 that is optimal for the particular spray application for which the spray gun 106 is being used. The operational loadline 301, and hence the relationship between the output voltage V_{OUT} and load current I_{OUT} are chosen based on, for example, parameters such as the type of material being sprayed, such as the type of powder or liquid, the shape of the part 101 being sprayed, required coating rate and/or the like.

The operational loadline 301 may extend from a “no load” or open circuit point to a maximum load or “short circuit” point, and at the “no load” point, the maximum amount of output voltage V_{OUT} is delivered. However, a desired and/or target operating range of output voltage V_{OUT} and load current I_{OUT} that is necessary for the spray gun to properly deliver its charged spray coating may be somewhere in the middle of the operational loadline 301, where the output voltage V_{OUT} is significantly lower than the maximum output voltage at the “no load” point and higher than the minimum output voltage at the “short circuit” point.

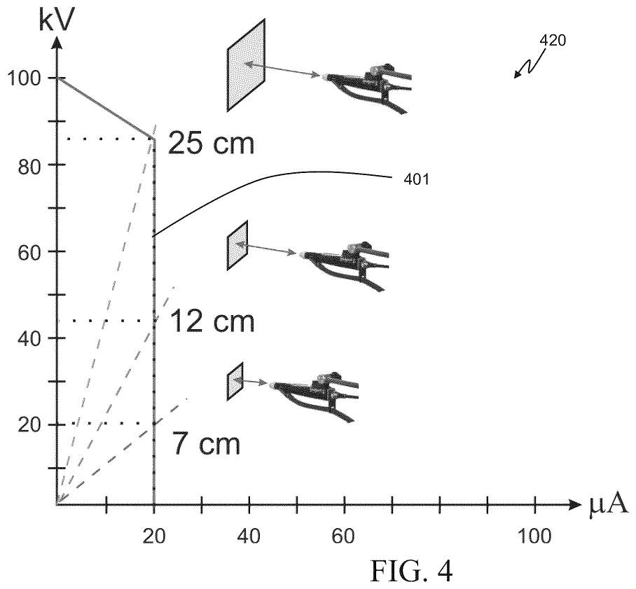

FIG. 4 illustrates an exemplary graph 420 of an operational loadline 401 of the voltage multiplier circuit 204 operating in a current limiting mode, according to an aspect of this disclosure. In the current limiting mode, the load current I_{OUT} is held constant and the output voltage V_{OUT} is adjusted to maintain a desired current level. As illustrated, the load current I_{OUT} is held constant at 20 μA. The voltage change dynamics can be indicative of the gun-to-part distance change.

Based on the relationship of the output voltage V_{OUT} and load current I_{OUT} of the operational loadline 301, in typical spray devices, if the location of the spray gun 106 is moved closer to or away from the part 101, the output voltage V_{OUT} and load current I_{OUT} change. For example, in the voltage limiting mode, as shown in the exemplary graph 300, at a point A on the operational loadline 301, the spray gun 106 can be spaced approximately 10 inches (250 mm) away from the part 101. At point A, the load current I_{OUT} is approximately 20 μA. At a point B on the loadline 301, the spay gun 106 can be spaced approximately 7 inches (178 mm) away from the part 101. At point B, the load current I_{OUT} is approximately 43 μA. At a point C on the loadline 301, the spay gun 106 can be spaced approximately 3 inches (76 mm) away from the part 101. At point C, the load current I_{OUT} is approximately 79 μA. It should be noted that other implementations will have different values of voltage and current. In this regard, the various aspects of the disclosure are equally applicable to those other implementations. In typical electrostatic spray devices, a change in the output voltage V_{OUT} and load current I_{OUT} along the operational loadline 301 due to the position of the spray gun 106 relative to the part 101 can affect the electric field 212 created by the electrode 108, and therefore, affect the coating applied to the part 101.

In the voltage limiting mode (e.g., FIG. 3), the controller 222 shows an output voltage V_{OUT} of approximately 100 kV. The load current I_{OUT} can be used to infer the gun-to-part distance. For example, as the spray gun 106 moves closer to the part 101, the current increases, providing an indication to the controller 222 that the spray gun 106 has moved closer to the part 101. In the current limiting mode (e.g., FIG. 4), the voltage fluctuation can be used to infer the gun-to-part distance. For example, as the spray gun 106 moves close to the part 101, the voltage decreases, providing an indication to the controller 222 that the spray gun 106 has moved closer to the part 101.

With reference to FIGS. 3 and 4 and the description thereof, it should be noted that aspects of the disclosure are not limited to particular loadlines, such as the operational loadline 301 illustrated in FIG. 3 and the operational loadline 401 illustrated in FIG. 4. In this regard, aspects of the disclosure may additionally be applicable to implementations that may change the shape of a loadline. For example, load lines adaptable to different applications and types of product. Moreover, aspects of the disclosure are applicable to systems that can implement a change in current limit and also the dynamics of voltage adjustment in response to changes in gun-to-part distance. In this regard, in all cases there will be a relation between the voltage, the current, and the resistance (gun-to-part distance) where aspects of the disclosure may be implemented to control either the voltage or the current and monitor the changes in the uncontrolled parameter in response to the changes in the gun-to-part distance.

With reference to FIGS. 1 and 2, the gun control system 110 may be configured to adjust a flow rate of the air supplied by the air supply 104 to increase/decrease the spray velocity and cloud density of the air and material combination sprayed onto the part 101. The gun control system 110 is connected between the spray gun 106 and the air supply 104. Based on parameters detected by the gun control system 110, as further described herein, the gun control system 110 can control, for example, an input velocity of the air supplied by the air supply 104. In an aspect, the gun control system 110 can control the volume of coating material supplied by the spray material supply 102 based on parameters detected by the gun control system 110. The input velocity can be controlled based on a location of the spray gun 106 relative to the part 101 to maintain at least one of the output voltage V_{OUT} and the load current I_{OUT} within a desired and/or target range.

The gun control system 110 can include a sensor 220 and a controller 222. The sensor 220 is configured to detect at least one of the output voltage V_{OUT} and load current I_{OUT} supplied by the voltage multiplier circuit 204 to the electrode 108. The sensor 220 can include one or more sensors. For example, one sensor can be configured to detect the output voltage V_{OUT}, and another sensor can be configured to detect the load current I_{OUT}. It will be appreciated that the gun control system 110 can include other sensors configured to sense other parameters of the voltage input circuit 200. In an aspect, the sensor 220 is configured to detect the output voltage V_{OUT} and the load current I_{OUT} through the resistor 210. The sensor 220 can provide one or more signals to the controller 222 indicative of the output voltage V_{OUT} and load current I_{OUT}.

The controller 222 may be configured to receive signals indicative of the output voltage V_{OUT} and the load current I_{OUT} transmitted by the sensor 220. In this regard, the gun control system 110 and/or other component of the electrostatic spray coating device 100 may include one or more conditioning circuits, analog to digital converters, filters, and/or the like to receive the signals. The controller 222 can record the output voltage V_{OUT} and the load current I_{OUT} and control the air supplied by the air supply 104 based on at least one of the output voltage V_{OUT} and the load current I_{OUT} received. In an aspect, the controller 222 is configured to dynamically control the air supply 104 to maintain at least one of the output voltage V_{OUT} and the load current I_{OUT} at a desired level or within a desired and/or target range during operation of the spray gun 106. In this regard, the gun control system 110 and/or other component of the electrostatic spray coating device 100 may include one or more digital to analog converters, driver circuits, and/or the like to dynamically control the air supply 104. The controller 222 may be an electronic control unit, computing device, central processing unit, and/or other data manipulation device that may be used to facilitate control and coordination of any of the methods or procedures described herein. While the controller 222 is represented as a single unit, in other aspects the controller 222 may be distributed as a plurality of distinct but interoperating units, incorporated into another component, or located at different locations on or off the electrostatic spray coating device 100.

In an aspect, the controller 222 includes a processor 224, such as a microprocessor, microcontroller, and/or the like, and a memory 226. The processor 224 can be operatively coupled to each of the sensor 220, the memory 226, the air supply 104, and/or the like. The processor 224 can be configured to receive and process signals from the sensor 220, the memory 226, and the air supply 104, and to store the signals in memory 226.

The memory 226 can include random access memory (RAM), read-only memory (ROM), or both. The memory 226 can store, for example, the desired and/or target values or ranges for the output voltage V_{OUT} and the load current I_{OUT}. The memory 226 may also store computer executable code including at least one algorithm for controlling the air supply to adjust the input velocity or volumetric flow rate of the air from the air supply 104.

The gun control system 110 can include fewer or more components to control the electrostatic spray coating device 100. For example, the gun control system 110 can include a communication interface to communicate with remote monitoring locations, disconnect switches, solenoids, drivers, transceivers, and/or the like for sending and receiving information and commands, a user interface for receiving input from the user, or still other components to facilitate control of the electrostatic spray coating device 100

The desired and/or target values or ranges for the output voltage V_{OUT} and the load current I_{OUT} can be predetermined and stored in the memory 226. Alternatively, the user can input and store the desired and/or target values or ranges for the output voltage V_{OUT} and the load current I_{OUT} in the memory 226. In an aspect, the user can adjust the desired and/or target values or ranges for the output voltage V_{OUT} and the load current I_{OUT} that are stored in the memory 226. For example, depending on the spray material 103 and/or the part 101, a certain electric field 212 created by the electrode 108 may be desired for achieving an acceptable coating. The user can set at least one of the desired and/or target values or ranges for the output voltage V_{OUT} and the load current I_{OUT} to create the desired electric field 212. During operation, the gun control system 110 can adjust the air supplied by the air supply 104 to maintain at least one of the output voltage V_{OUT} and the load current I_{OUT} at the desired and/or target value or within the desired and/or target range to create and maintain the desired electric field 212.

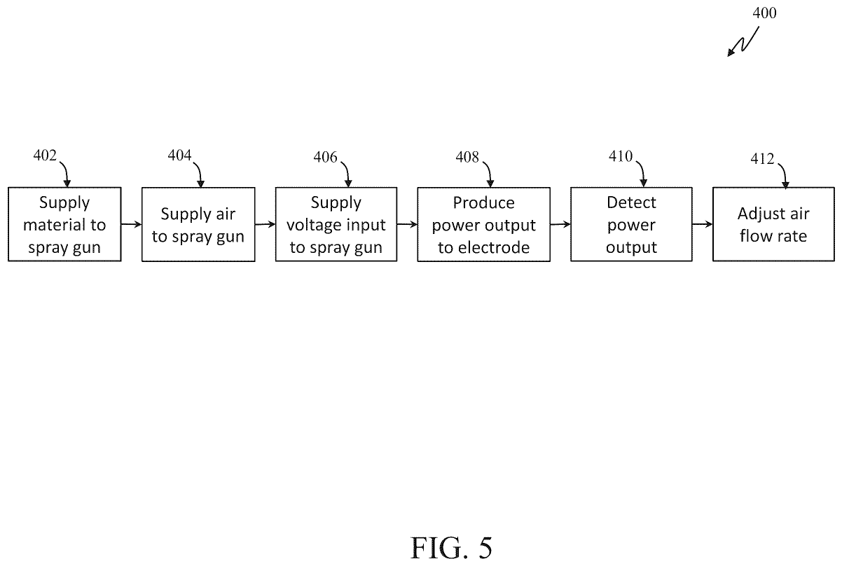

FIG. 5 illustrates a flowchart depicting a method 400 for controlling the flow of the spray material 103 through the electrostatic spray coating device 100, according to an aspect of this disclosure. The aspects illustrated in FIG. 5 and described in relation to the same, may include, implement, utilize, and/or the like any other aspects, components, features, and/or the like of the disclosure as described herein. The steps illustrated in relation to the method 400 may be implemented in a different order, the steps may be combined, additional steps included, and/or the like. Moreover, the method 400 may be implemented as software by the processor 224.

At step 402, the spray material 103 may be supplied to the spray gun 106 from the spray material supply 102 via the conduit 116. The spray material 103 is flowed into and through the spray channel 117 of the spray gun 106 along the flow path 119. The spray material 103 can be supplied by the spray material supply 102 at a substantially constant rate (e.g. substantially constant flow volume rate, mass rate, velocity, and/or the like). The spray material 103 is combined with the air in the spray channel 117.

At step 404, the air is supplied to the spray gun 106 from the air supply 104 via the conduit 118. The air is flowed into and through the spray channel 117 of the spray gun 106 along a flow path 119 (see FIG. 1). The air is combined with the spray material 103 in the spray channel 117. The air supply 104 flows the air into the spray channel 117 with an input velocity. In this regard, the input velocity may have a direct or indirect correlation to a pressure provided by the air supply 104. In an aspect, the controller 222 can be pre-programmed with an initial input velocity of the air. The controller 222 can control the air supply 104 to set the input velocity of the air to the initial input velocity when the spray gun 106 is activated to spray. It will be appreciated that the air supply 104 can be controlled by the controller 222 to supply the air based on a velocity of the air, a volume of the air (e.g. volumetric flow rate), a pressure of the air, and/or other airflow parameter for controlling the flow of the air, which are defined herein as an airflow characteristic. In an aspect, the air supply 104 can include a solenoid valve (not shown) that can be controlled by the controller 222 to adjust and control the input velocity of the air.

The air and spray material 103 combination are flowed along the flow path 119 and are placed in a charging area of an applicator so as receive charging by ion bombardment, placed in electrical contact with the electrode 108, a corona associated with the electrode 108, an electric field with the electrode 108, and/or the like. The electrode 108 can be positioned along the flow path 119 adjacent to the outlet 107 of the spray gun 106, either within the spray gun 106 (along the flow path 119 upstream from the outlet 107 of the spray gun 106) or exterior to the spray gun 106 (e.g. along the flow path 119 downstream from the outlet 107 of the spray gun 106). The air and spray material 103 combination is flowed through the outlet 107 of the spray gun 106 and onto the part 101.

In an aspect, the air and the spray material 103 can be supplied to the spray gun 106 together (e.g. venturi sprayer). For example, the air and spray material 103 can be combined prior to being supplied to the spray gun 106. Alternatively, the air and spray material 103 may be supplied to the spray gun 106 separately (e.g. high density sprayer). The air and the spray material 103 can be supplied to the spray gun 106 separately and combined within the spray channel 117 of the spray gun 106.

At step 406, the voltage input 202 supplies the input voltage V_{IN} to the voltage multiplier circuit 204. The input voltage V_{IN} is increased by the transformer 206 and the cascade 208. The increased input voltage V_{IN} is supplied across the resistor 210.

It will be appreciated that steps 402, 404, and 406 can be performed substantially simultaneously. For example, when the electrostatic spray coating device 100 is activated, the air can be supplied to the spray gun 106, the spray material 103 can be supplied to the spray gun 106, and the input voltage V_{IN} can be supplied to the voltage multiplier circuit 204 substantially simultaneously. This can allow the air and spray material 103 combination to be charged as soon as the air and spray material 103 combination begin flowing through the outlet 107 of the spray gun 106.

At step 408, the voltage multiplier circuit 204 may produce the power supply output that is supplied to the electrode 108. The power supply output is defined by at least the output voltage V_{OUT} and the load current I_{OUT}. The power supply output charges the electrode 108, which charges the air and spray material 103 combination that is sprayed onto the part 101.

At step 410, the sensor 220 detects the power supply output produced by the voltage multiplier circuit 204. For example, the sensor 220 detects at least one of the output voltage V_{OUT} and the load current I_{OUT}. The sensor 220 can transmit signals indicative of the output voltage V_{OUT} and the load current I_{OUT} to the controller 222. The controller 222 can store the output voltage V_{OUT} and the load current I_{OUT} in the memory 226.

In an aspect, the sensor 220 detects at least one of the output voltage V_{OUT} and the load current I_{OUT} through the resistor 210. The output voltage V_{OUT} and the load current I_{OUT} through the resistor 210 can change based on the position of the spray gun 106 relative to the part 101. For example, the resistance between the spray gun 106 and the part 101 increases as the spray gun 106 is moved away from the part 101. Similarly, when the spray gun 106 is moved closer to the part 101 the resistance between the spray gun 106 and the part 101 decreases. Based on the relationship between the resistance, the current, and the voltage (e.g. Ohm's law), the current between the spray gun 106 and the part 101 increases as the spray gun 106 is moved closer to the part 101. Similarly, the current between the spray gun 106 and the part 101 decreases as the spray gun 106 is moved away from the part 101. Further, the voltage drop across the resistor 210 as the spray gun 106 is moved closer to the part 101 is greater than the voltage drop across the resistor 210 as the spray gun 106 is moved further away from the part 101. The change in current and voltage drop based on the spray gun 106 position is illustrated in FIG. 3 (e.g. see point A (10 inches away) vs. point C (3 inches away)). As such, the distance between the spray gun 106 and the part 101 is related to the voltage drop and the current flowing between the spray gun 106 and the part 101. The voltage drop and the current flowing between the spray gun 106 and the part 101 can be approximated by detecting at least one of the output voltage V_{OUT} and the load current I_{OUT} through the resistor 210.

At step 412, the controller 222 adjusts the input velocity of the air supplied by the air supply 104 based on at least one of the output voltage V_{OUT} and the output load current I_{OUT} detected by the sensor 220. The processor 224 can compare at least one of the output voltage V_{OUT} and the output load current I_{OUT} to the desired and/or target value or range of the respective output voltage V_{OUT} and output load current I_{OUT} stored in memory 226. The desired and/or target value or range of the respective output voltage V_{OUT} and output load current I_{OUT} can relate to a gun-to-part distance. In an aspect, during voltage limiting mode, the output load current I_{OUT} is compared to the desired and/or target value of the output load current I_{OUT} stored in memory 226. Based on the comparison, the controller 222 transmits a signal to the air supply 104 to adjust the input velocity. For example, if the detected output load current I_{OUT} is greater than the desired and/or target value of the output load current I_{OUT} stored in memory 226, then the controller 222 can send a signal to the air supply 104 to reduce the input velocity of the air. By reducing the input velocity of the air, the air and spray material 103 combination flowing through the spray gun 106 is reduced, thereby softening the application of the air and spray material 103 applied by the spray gun 106 onto the part 101. The controller 222 can be configured to continuously or discreetly send a signal to the air supply 104 to reduce the input velocity of the air until the velocity reaches a desired and/or target velocity. The desired and/or target velocity can be associated with the output load current I_{OUT} and stored in memory 226. Similarly, if the detected output load current I_{OUT} is less than the desired and/or target value of the output load current I_{OUT} stored in memory 226, then the controller 222 can send a signal to the air supply 104 to increase the input velocity of the air to achieve the desired and/or target velocity. By increasing the input velocity of the air, the air and spray material 103 combination flowing through the spray gun 106 is increased to create a better application condition. The controller 222 can be configured to continuously send a signal to the air supply 104 to increase the input velocity of the air until velocity reaches the desired and/or target value. In an aspect, the controller 222 is configured to incrementally control the air supply 104 to adjust the input velocity of the air. In aspects, the controller 222 may control the air supply 104 based on at least one of the output voltage V_{OUT} and the output load current I_{OUT} utilizing a lookup table that may be stored in the memory 226. In particular, the lookup table may associate values to control the air supply 104 based on at least one of the output voltage V_{OUT} and the output load current I_{OUT}. In aspects, the controller 222 may control the air supply 104 based on at least one of the output voltage V_{OUT} and the output load current I_{OUT} utilizing an algorithm that may be stored in the memory 226. In particular, the algorithm may associate values to control the air supply 104 based on at least one of the output voltage V_{OUT} and the output load current I_{OUT}. In aspects, the controller 222 may control the air supply 104 based on at least one of the output voltage V_{OUT} and the output load current I_{OUT} utilizing artificial intelligence and/or machine learning implemented by the processor 224. In particular, the artificial intelligence and/or machine learning may associate values to control the air supply 104 based on at least one of the output voltage V_{OUT} and the output load current I_{OUT}.

In an aspect, the sensor 220 may be implemented as a distance sensor. The distance sensor can be configured to sense a distance between the spray gun 106 and the part 101. Based on the sensed distance between the spray gun 106 and the part 101, the controller 222 can control the input velocity of the air supplied by the air supply 104. For example, if the distance detected by the distance sensor is small, indicating that the spray gun 106 is close to the part 101, the controller 222 can reduce the input velocity of the air supplied by the air supply 104. If the distance detected by the distance sensor is large indicating that the spray gun 106 is spaced further away from the part 101, the controller 222 can increase the input velocity of the air supplied by the air supply 104.

The controller 222 can dynamically control the air supply 104 to adjust the input velocity of the air. As the spray gun 106 moves between positions closer to and further away from the part 101, the controller 222 can send signals to the air supply 104 to control air velocity. It will be appreciated that the controller 222 can control the air supply 104 to adjust the input velocity of the air until the velocity reaches the desired and/or target velocity, or either of the maximum or minimum input velocity of the air is achieved. For example, the air supply 104 can be configured to supply the air at a minimum input velocity up to a maximum input velocity. The minimum and maximum input velocities can be a function of the air supply 104, the spray gun 106, combinations thereof, or still other function. The minimum and maximum input velocities can be stored in the memory 226 of the controller 222.

As may be appreciated by those skilled in the art, the illustrated structure in FIG. 5 may be a logical structure and/or a physical one. Accordingly, the illustrated steps can be implemented by employing various hardware, software components, and/or the like. In one aspect, one or more of the processes may be implemented as software, software program modules, and/or the like.

The following are a number of nonlimiting EXAMPLES of aspects of the disclosure. One EXAMPLE includes: EXAMPLE 1. An electrostatic material spray device, includes: an air supply configured to supply air with an input velocity; a spray body defining a spray channel in fluid communication with the air supply and a spray material supply to receive the air from the air supply and a spray material from the spray material supply and to transmit an air and spray material combination along a flow path; a voltage multiplier circuit configured to receive a voltage input and to produce a power supply output that is supplied to an electrode positioned along the flow path, the power supply output having an output voltage and an output load current; a sensor configured to detect at least one of the output voltage and the output load current; and a controller operatively connected to the sensor and the air supply and configured to control the air supply to adjust the input velocity of the air based on the at least one of the output voltage and the output load current detected by the sensor.

The above-noted EXAMPLE may further include any one or a combination of more than one of the following EXAMPLES: 2. The electrostatic material spray device of any EXAMPLE herein, includes: a voltage input source configured to supply the voltage input to the voltage multiplier circuit. 3. The electrostatic material spray device of any EXAMPLE herein, where the voltage multiplier circuit includes a resistor, and where the sensor is configured to detect the at least one of the output voltage and the output load current through the resistor. 4. The electrostatic material spray device of any EXAMPLE herein, where the sensor is configured to detect the output load current through the resistor, and where the controller is configured to control the air supply to adjust the input velocity of the air based on the output load current detected by the sensor. 5. The electrostatic material spray device of any EXAMPLE herein, where the controller is further configured to compare the output load current to a target output load current, such that if the output load current is greater than the target output load current, the controller controls the air supply to reduce the input velocity of the air. 6. The electrostatic material spray device of any EXAMPLE herein, where the voltage multiplier circuit includes a transformer configured to increase the voltage input. 7. The electrostatic material spray device of any EXAMPLE herein, includes: a powder supply configured to supply a substantially constant flow volume of a powder to the spray channel. 8. The electrostatic material spray device of any EXAMPLE herein, where the electrode is positioned in the flow path of the air and spray material combination. 9. The electrostatic material spray device of any EXAMPLE herein, where the electrode is positioned within the spray channel of the spray body.

One EXAMPLE includes: EXAMPLE 10. A method for controlling a material flow through an electrostatic powder spray device including a spray body that defines a spray channel having an outlet, the method includes: flowing air through the spray channel at an input velocity; flowing a spray material through the spray channel such that an air and spray material combination flow through the outlet along a flow path; producing a power supply output that is supplied to an electrode, the power supply output having an output voltage and an output load current, the electrode being positioned within the flow path of the air and spray material combination; detecting at least one of the output voltage and the output load current; and adjusting the input velocity of the air based on the at least one of the output voltage and the output load current.

The above-noted EXAMPLE may further include any one or a combination of more than one of the following EXAMPLES: 11. The method of any EXAMPLE herein, where the power supply output is produced by a voltage multiplier circuit, the method includes: supplying a voltage input to the voltage multiplier circuit. 12. The method of any EXAMPLE herein, where the voltage multiplier circuit includes a resistor, and where the detecting the at least one of the output voltage and the output load current includes detecting the at least one of the output voltage and the output load current through the resistor. 13. The method of any EXAMPLE herein, includes, comparing the output load current to a target output load current; where if the output load current is greater than the target output load current, adjusting an air supply to reduce the input velocity of the air; and where if the output load current is less than the target output load current, adjusting the air supply to increase the input velocity of the air. 14. The method of any EXAMPLE herein, where the flowing the spray material through the spray channel includes supplying a substantially constant flow volume of the spray material to the spray channel. 15. The method of any EXAMPLE herein, where the adjusting the input velocity of the air includes incrementally adjusting the input velocity of the air. 16. The method of any EXAMPLE herein, where the adjusting the input velocity of the air is performed by a controller, where the controller is configured to dynamically adjust the input velocity of the air during the flowing the air through the spray channel, the flowing the spray material through the spray channel, and the producing the power supply output.

One EXAMPLE includes: EXAMPLE 17. A control system for controlling an air flow through an electrostatic powder spray device configured to spray an air and spray material combination to coat a spray part and further configured to provide a power supply output having an output voltage and an output load current to an electrode configured to provide a charge to the air and spray material combination, the control system includes: a sensor configured to detect at least one of the output voltage and the output load current; and a controller operatively connected to the sensor and an air supply and configured to control the air supply to adjust an input velocity of the air supplied by the air supply based on the at least one of the output voltage and the output load current detected by the sensor.

The above-noted EXAMPLE may further include any one or a combination of more than one of the following EXAMPLES: 18. The control system of any EXAMPLE herein, where the controller is further configured to compare the output load current to a target output load current, such that if the output load current is greater than the target output load current, the controller controls the air supply to reduce the input velocity of the air. 19. The control system of any EXAMPLE herein, where the controller is further configured such that if the output load current is less than the target output load current, the controller controls the air supply to increase the input velocity of the air.

One EXAMPLE includes: EXAMPLE 20. An electrostatic material spray device includes: an air supply configured to supply air with an airflow characteristic; a spray body defining a spray channel in fluid communication with the air supply and a spray material supply to receive the air from the air supply and a spray material from a spray material supply and to transmit an air and spray material combination along a flow path; a voltage multiplier circuit configured to receive a voltage input and to produce a power supply output that is supplied to an electrode positioned along the flow path, the power supply output having an output voltage and an output load current; a sensor configured to detect at least one of the output voltage and the output load current; and a controller operatively connected to the sensor and the air supply and configured to control the air supply to adjust the airflow characteristic of the air based on the at least one of the output voltage and the output load current detected by the sensor.

The above-noted EXAMPLE may further include any one or a combination of more than one of the following EXAMPLES: 21. The electrostatic material spray device of any EXAMPLE herein, includes: a voltage input source configured to supply the voltage input to the voltage multiplier circuit. 22. The electrostatic material spray device of any EXAMPLE herein, where the voltage multiplier circuit includes a resistor, and where the sensor is configured to detect the at least one of the output voltage and the output load current through the resistor. 23. The electrostatic material spray device of any EXAMPLE herein, where the sensor is configured to detect the output load current through the resistor, and where the controller is configured to control the air supply to adjust the airflow characteristic of the air based on the output load current detected by the sensor. 24. The electrostatic material spray device of any EXAMPLE herein, where the controller is further configured to compare the output load current to a target output load current, such that if the output load current is greater than the target output load current, the controller controls the air supply to reduce the airflow characteristic of the air. 25. The electrostatic material spray device of any EXAMPLE herein, where the voltage multiplier circuit includes a transformer configured to increase the voltage input. 26. The electrostatic material spray device of any EXAMPLE herein, includes: a powder supply configured to supply a substantially constant flow volume of a powder to the spray channel. 27. The electrostatic material spray device of any EXAMPLE herein, where the electrode is positioned in the flow path of the air and spray material combination. 28. The electrostatic material spray device of any EXAMPLE herein, where the electrode is positioned within the spray channel of the spray body.

One EXAMPLE includes: EXAMPLE 29. A method for controlling a material flow through an electrostatic powder spray device including a spray body that defines a spray channel having an outlet, the method includes: flowing air with an airflow characteristic through the spray channel; flowing a spray material through the spray channel such that an air and spray material combination flow through the outlet along a flow path; producing a power supply output that is supplied to an electrode, the power supply output having an output voltage and an output load current, the electrode being positioned within the flow path of the air and spray material combination; detecting at least one of the output voltage and the output load current; and adjusting the airflow characteristic of the air based on the at least one of the output voltage and the output load current.

The above-noted EXAMPLE may further include any one or a combination of more than one of the following EXAMPLES: 30. The method of any EXAMPLE herein, where the power supply output is produced by a voltage multiplier circuit, the method includes: supplying a voltage input to the voltage multiplier circuit. 31. The method of any EXAMPLE herein, where the voltage multiplier circuit includes a resistor, and where the detecting at least one of the output voltage and the output load current includes detecting the at least one of the output voltage and the output load current through the resistor. 32. The method of any EXAMPLE herein, includes, comparing the output load current to a target output load current; where if the output load current is greater than the target output load current, adjusting an air supply to reduce the airflow characteristic of the air; and where if the output load current is less than the target output load current, adjusting the air supply to increase the airflow characteristic of the air. 33. The method of any EXAMPLE herein, where the flowing the spray material through the spray channel includes supplying a substantially constant flow volume of the spray material to the spray channel. 34. The method of any EXAMPLE herein, where the adjusting the airflow characteristic of the air includes incrementally adjusting the airflow characteristic of the air. 35. The method of any EXAMPLE herein, where the adjusting the airflow characteristic of the air is performed by a controller, where the controller is configured to dynamically adjust the airflow characteristic of the air during the flowing the air through the spray channel, the flowing the spray material through the spray channel, and the producing the power supply output.

One EXAMPLE includes: EXAMPLE 36. A control system for controlling an air flow through an electrostatic powder spray device configured to spray an air and spray material combination to coat a spray part and further configured to provide a power supply output having an output voltage and an output load current to an electrode, the electrode being configured to provide a charge to the air and spray material combination, the control system includes: a sensor configured to detect at least one of the output voltage and the output load current; and a controller operatively connected to the sensor and an air supply and configured to control the air supply to adjust an airflow characteristic of the air supplied by the air supply based on the at least one of the output voltage and the output load current detected by the sensor.

The above-noted EXAMPLE may further include any one or a combination of more than one of the following EXAMPLES: 37. The control system of any EXAMPLE herein, where the controller is further configured to compare the output load current to a target output load current, such that if the output load current is greater than the target output load current, the controller controls the air supply to reduce the airflow characteristic of the air. 38. The control system of any EXAMPLE herein, where the controller is further configured such that if the output load current is less than the target output load current, the controller controls the air supply to increase the airflow characteristic of the air.

The disclosure may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

Further in accordance with various aspects of the disclosure, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the disclosure is considered to include a tangible storage medium or distribution medium, as listed herein and including art-recognized equivalents and successor media, in which the software implementations herein are stored.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

The artificial intelligence and/or machine learning may utilize any number of approaches including one or more of cybernetics and brain simulation, symbolic, cognitive simulation, logic-based, anti-logic, knowledge-based, sub-symbolic, embodied intelligence, computational intelligence and soft computing, machine learning and statistics, and the like.

The electrostatic spray coating device 100 is versatile and can control and maintain the output voltage V_{OUT} and the load current I_{OUT} at or within desired and/or target levels or ranges to achieve the desired spray coating on the part 101 by dynamically controlling the input velocity of the air supplied by the air supply 104 without adjusting or changing either of the input voltage V_{IN} supplied by the voltage input 202 or the operational loadline 301.

It will be appreciated that the foregoing description provides examples of the disclosed system and method. However, it is contemplated that other implementations of the disclosure may differ in detail from the foregoing examples. For example, any of the embodiments disclosed herein can incorporate features disclosed with respect to any of the other embodiments disclosed herein. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

As one of ordinary skill in the art will readily appreciate from that processes, machines, manufacture, composition of matter, means, methods, or steps, presently existing or later to be developed that perform substantially the same function or achieve substantially the same result as the corresponding embodiments described herein may be utilized according to the present disclosure.

1-19. (canceled)

20. An electrostatic material spray device, comprising:
an air supply configured to supply air with an airflow characteristic;
a spray body defining a spray channel in fluid communication with the air supply and a spray material supply to receive the air from the air supply and a spray material from a spray material supply and to transmit an air and spray material combination along a flow path;
a voltage multiplier circuit configured to receive a voltage input and to produce a power supply output that is supplied to an electrode positioned along the flow path, the power supply output having an output voltage and an output load current;
a sensor configured to detect at least one of the output voltage and the output load current; and
a controller operatively connected to the sensor and the air supply and configured to control the air supply to adjust the airflow characteristic of the air based on the at least one of the output voltage and the output load current detected by the sensor.

21. The electrostatic material spray device of claim 20, further comprising:
a voltage input source configured to supply the voltage input to the voltage multiplier circuit.

22. The electrostatic material spray device of claim 20, wherein the voltage multiplier circuit includes a resistor, and wherein the sensor is configured to detect the at least one of the output voltage and the output load current through the resistor.

23. The electrostatic material spray device of claim 22, wherein the sensor is configured to detect the output load current through the resistor, and wherein the controller is configured to control the air supply to adjust the airflow characteristic of the air based on the output load current detected by the sensor.

24. The electrostatic material spray device of claim 23, wherein the controller is further configured to compare the output load current to a target output load current, such that if the output load current is greater than the target output load current, the controller controls the air supply to reduce the airflow characteristic of the air.

25. The electrostatic material spray device of claim 20, wherein the voltage multiplier circuit includes a transformer configured to increase the voltage input.

26. The electrostatic material spray device of claim 20, further comprising:
a powder supply configured to supply a substantially constant flow volume of a powder to the spray channel.

27. The electrostatic material spray device of claim 20, wherein the electrode is positioned in the flow path of the air and spray material combination.

28. The electrostatic material spray device of claim 27, wherein the electrode is positioned within the spray channel of the spray body.

29. A method for controlling a material flow through an electrostatic powder spray device including a spray body that defines a spray channel having an outlet, the method comprising:
flowing air with an airflow characteristic through the spray channel;
flowing a spray material through the spray channel such that an air and spray material combination flow through the outlet along a flow path;
producing a power supply output that is supplied to an electrode, the power supply output having an output voltage and an output load current, the electrode being positioned within the flow path of the air and spray material combination;
detecting at least one of the output voltage and the output load current; and
adjusting the airflow characteristic of the air based on the at least one of the output voltage and the output load current.

30. The method of claim 29, wherein the power supply output is produced by a voltage multiplier circuit, the method further comprising:
supplying a voltage input to the voltage multiplier circuit.

31. The method of claim 30, wherein the voltage multiplier circuit includes a resistor, and wherein detecting at least one of the output voltage and the output load current includes detecting the at least one of the output voltage and the output load current through the resistor.

32. The method of claim 29, further comprising,
comparing the output load current to a target output load current;
wherein if the output load current is greater than the target output load current, adjusting an air supply to reduce the airflow characteristic of the air; and
wherein if the output load current is less than the target output load current, adjusting the air supply to increase the airflow characteristic of the air.

33. The method of claim 29, wherein the flowing the spray material through the spray channel comprises supplying a substantially constant flow volume of the spray material to the spray channel.

34. The method of claim 29, wherein the adjusting the airflow characteristic of the air comprises incrementally adjusting the airflow characteristic of the air.

35. The method of claim 29, wherein the adjusting the airflow characteristic of the air is performed by a controller, wherein the controller is configured to dynamically adjust the airflow characteristic of the air during the flowing the air through the spray channel, the flowing the spray material through the spray channel, and the producing the power supply output.

36. A control system for controlling an air flow through an electrostatic powder spray device configured to spray an air and spray material combination to coat a spray part and further configured to provide a power supply output having an output voltage and an output load current to an electrode, the electrode being configured to provide a charge to the air and spray material combination, the control system comprising:
a sensor configured to detect at least one of the output voltage and the output load current; and
a controller operatively connected to the sensor and an air supply and configured to control the air supply to adjust an airflow characteristic of the air supplied by the air supply based on the at least one of the output voltage and the output load current detected by the sensor.

37. The control system of claim 36, wherein the controller is further configured to compare the output load current to a target output load current, such that if the output load current is greater than the target output load current, the controller controls the air supply to reduce the airflow characteristic of the air.

38. The control system of claim 37, wherein the controller is further configured such that if the output load current is less than the target output load current, the controller controls the air supply to increase the airflow characteristic of the air.

39. The control system of claim 36, wherein the airflow characteristic is one or more of a velocity of the air, a volume of the air, and a pressure of the air.

40. The method of claim 29, wherein the airflow characteristic is one or more of a velocity of the air, a volume of the air, and a pressure of the air.

41. The electrostatic material spray device of claim 20, wherein the airflow characteristic is one or more of a velocity of the air, a volume of the air, and a pressure of the air.
